(19) United States
(12) Patent Application Publication
(10) Pub. No.: US 2011/0004871 A1
(43) Pub. Date: Jan. 6, 2011

(54) EMBEDDED ELECTRONIC DEVICE AND FIRMWARE UPDATING METHOD THEREOF

(75) Inventor: Guo-Dong Liu, Nanjing (CN)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/786,783

(22) Filed: May 25, 2010

(30) Foreign Application Priority Data
Jul. 3, 2009 (TW) 98122620

(51) Int. Cl. G06F 9/44

(52) U.S. Cl. 717/173; 713/2

(57) ABSTRACT

An embedded electronic device and a firmware updating method thereof are provided. The embedded electronic device includes a first storage unit and a second storage unit with a profile partition, a data partition and a system partition. In the method, a firmware package with a setup information file and a plurality of firmware code files is first downloaded into the first storage unit. The setup information file and the firmware code files are written in the profile partition and the data partition, respectively. The embedded electronic device is re-started, and a boot loader in the system partition is executed to sequentially read each firmware code file from the data partition for writing in the system partition. A write-in progress in the profile partition is updated upon completion of writing of each firmware code file.

### CROSS-REFERENCE TO RELATED APPLICATION

This application claims the priority benefit of Taiwan application serial no. 98122620, filed on Jul. 3, 2009. The entirety of the above-mentioned patent application is hereby incorporated by reference herein and made a part of this specification.

### BACKGROUND OF THE INVENTION

1. Field of the Invention

The present invention relates to a firmware updating method, and more particularly, to a method for updating a firmware of an embedded electronic device.

2. Description of Related Art

Following the development of technology, currently the methods for updating an embedded electronic device become more and more versatile. For example, a firmware over-the-air technology is used to update the embedded electronic device. Another example is to use the universal serial bus (USB) link to perform the firmware update.

In general, the firmware is stored in a NAND flash. If it needs update, the user first downloads a new version of the firmware and executes firmware updating program. After the firmware updating program checks the new version of firmware and determines that the new version of firmware is correct, the new version of firmware is directly burned into the NAND flash to overwrite the old version. After the update is completed, the system is restarted to allow the new version of firmware to operate.

However, during the course of firmware updating, a system crash, interrupt of power supply, or firmware updating program errors may occur. If one of these problems occurs, the new version of firmware cannot be normally booted because the new version of firmware has not been completely written into the NAND flash. On the other hand, the old version of firmware cannot be booted, either, because the old version of firmware is partially overwritten by the new version. As such, the embedded electronic device cannot normally operate due to the lack of a complete firmware.

### SUMMARY OF THE INVENTION

Accordingly, the present invention is directed to a firmware updating method, which can avoid system damage caused by interruption of update.

The present invention is also directed to an embedded electronic device which is capable of continuing to update the firmware codes that was not updated in the previous update according to a write-in progress of the previous writing operation.

The present invention provides a firmware updating method applied to an embedded electronic device. The embedded electronic device includes a first storage unit and a second storage unit. The second storage unit includes a profile partition, a data partition and a system partition. The system partition at least stores a firmware of the embedded electronic device. The method comprises downloading a firmware package into the first storage unit, wherein the firmware package including a setup information file and a plurality of firmware code files. The setup information file and the firmware code files are written to the profile partition and the data partition, respectively. The embedded electronic device is restarted and a boot loader in the system partition is executed to execute a firmware writing operation. The firmware writing operation comprises sequentially reading the firmware code files from the data partition and writing the firmware code files into the system partition according to the setup information file in the profile partition, and updating a write-in progress in the profile partition upon completion of writing of each of the firmware code files, such that after the embedded electronic device is restarted after an interruption of power supply, the boot loader continues to write the rest of the firmware code files into the system partition according to the write-in progress.

The present invention additionally provides an embedded electronic device including a first storage unit, a second storage unit and a processing unit. The first storage unit is used to storage a loaded firmware package including a setup information file and a plurality of firmware code files. The second storage unit includes a profile partition, a data partition and a system partition, and the system partition at least stores a firmware of the embedded electronic device. The processing unit is coupled to the first storage unit and a second storage unit, wherein the processing unit is adapted to download a firmware package into the first storage unit, fetch the setup information file and the firmware code files so as to write the same to the profile partition and the data partition, respectively; and execute a boot loader in the system partition to execute a firmware writing operation if the embedded electronic device is restarted. The firmware writing operation comprises sequentially reading the firmware code files from the data partition and writing the firmware code files into the system partition according to the setup information file in the profile partition; and updating a write-in progress in the profile partition upon completion of writing of each of the firmware code files, such that after the embedded electronic device is restarted after an interruption of power supply, the boot loader continues to write the rest of the firmware code files into the system partition according to the write-in progress.

In summary, the present invention is proposed to address the termination problem occurring during updating of the firmware package, i.e. when the embedded electronic device is restarted due to an interruption of power supply or other accidents, the embedded electronic device can continue to update the rest of firmware code files according to the write-in progress of the previous writing operation, increasing the possibility of successful firmware update. In other words, the write-in progress of the firmware code files is recorded during updating. This makes sure that, even if the embedded electronic device is restarted during any of the writing stages, the embedded electronic device can continue to update the rest of the firmware code files.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a flow chart of a firmware updating method according to one embodiment of the present invention.

FIG. 2 is a flow chart of a method for writing the setup information file and firmware code files according to one embodiment of the present invention.

FIG. 3 is a flow chart of firmware writing operation according to one embodiment of the present invention.

FIG. 4 is a block diagram of an embedded electronic device according to one embodiment of the present invention.

FIG. 5 illustrates an exemplary second storage unit according to one embodiment of the present invention.

FIG. 6 illustrates a NAND flash memory according to one embodiment of the present invention.

### DESCRIPTION OF THE EMBODIMENTS

For embedded electronic devices that take the NAND flash as a carrier, they cannot be protected against interruption of power supply during the firmware updating. Therefore, the interruption of power supply or a man-made termination during the firmware update may bring an irreparable device crash. To this end, the present invention proposes an embedded electronic device and a method for updating a firmware of the embedded electronic device, such that after restarted, the embedded electronic device can continue to update according to the write-in progress of the previous writing operation, thus increasing the possibility of successful firmware update.

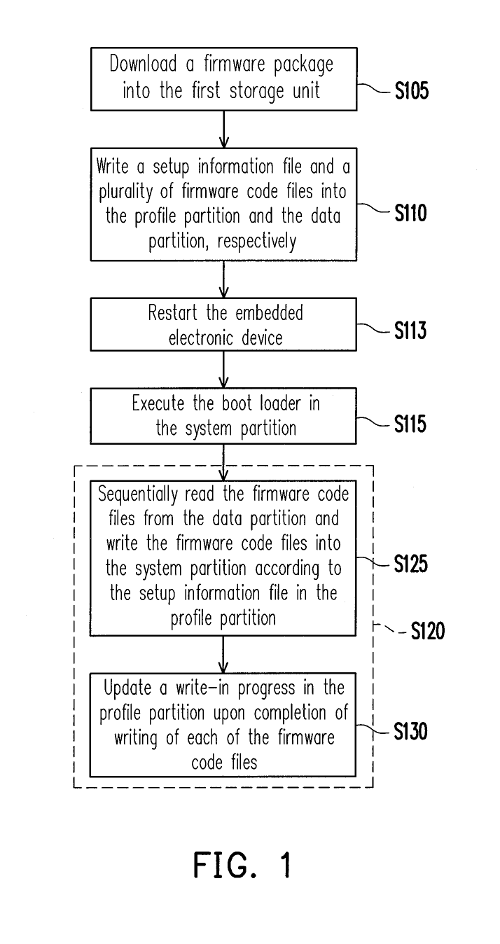

FIG. 1 is a flow chart of a firmware updating method according to one embodiment of the present invention. In this embodiment, the method is performed on an embedded electronic device for updating a firmware of the embedded electronic device. The embedded electronic device includes a first storage unit and a second storage unit. The second storage unit includes a profile partition, a data partition and a system partition.

Referring to FIG. 1, at step S105, a firmware package including a setup information file and a plurality of firmware code files is downloaded into the first storage unit. Here, the setup information file is, for example, an INF file used to record information such as addresses of sections into which the respective firmware code files are to be written, thereby enabling writing of the firmware code files.

More specifically, the firmware package is downloaded in a wireless manner via a user interface (UI). In addition, after the firmware package is downloaded into the first storage unit, the cycle redundancy check (CRC) code of the firmware package may further be checked via the UI to confirm integrity of the firmware package. Furthermore, if the UI detects that a firmware package already exists in the first storage unit prior to downloading of the firmware package, the UI will interrupt the wireless download request and proceed to a next step.

In the present embodiment, the first storage unit is, for example, a pluggable Trans-Flash (TF) card (i.e. a micro SD card) which supports over-the-air (OTA) data exchange. The second storage unit is, for example, a NAND flash memory to be used as a carrier of the embedded electronic device. However, these are for the purposes of illustration only and should not be regarded as limiting.

At step S110, the setup information file and the firmware code files are written into the profile partition and the data partition, respectively. In particular, in parsing the firmware package in the first storage unit to the second storage unit, the setup information file is recorded into the profile partition in a binary manner. At this time, the UI prompts that the firmware package starts updating. Then, a header message of the firmware package is parsed such that the firmware code files are retrieved from the firmware package and written into the data partition of the second storage so as to be transformed into image data based on the header message.

In other words, the setup information file and firmware code files are first transformed into directly readable image data to be stored in the second storage unit, such that a boot loader, which does not support the file system, can also directly read the firmware code files from the second storage unit.

At step S113, the embedded electronic device is restarted. After the restart, the boot loader in the system partition is executed at step S115. At step S120, the firmware writing operation is then performed through the boot loader. The firmware writing operation includes the operation of step S125 and the operation of step S130 as described below.

At step S125, the firmware code files are sequentially read from the data partition and written into the system partition according to the setup information file in the profile partition. The write-in progress in the profile partition is updated at step S130 upon completion of writing of each firmware code file. As such, after the embedded electronic device is restarted after an interruption of power supply, the boot loader is able to continue to write the rest of the firmware code files into the system partition according to the write-in progress.

It is noted that before the firmware code files are written into the system partition, it may be determined that whether the size of a firmware code file to be written exceeds a predetermined size (e.g. 5 MB). If the file size exceeds 5 MB, the write-in progress is updated upon completion of writing of each 5 M of the firmware file. Besides, the write-in progress is updated again upon completion of writing of the entire firmware code file. On the other hand, if the file size does not exceed 5 MB, the write-in progress is updated only upon completion of writing of each firmware code file. For example, if one firmware code file is 8 MB, the write-in progress is recorded upon completion of writing of 5 MB of the 8 M file and is recorded again upon completion of writing of the entire 8 M file.

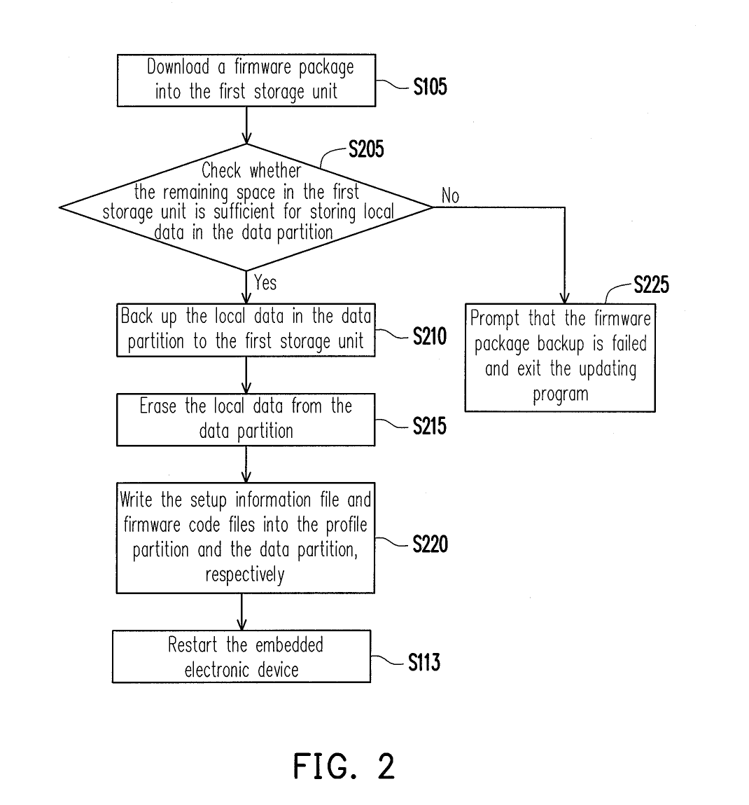

FIG. 2 is a flow chart of a method for writing the setup information file and firmware code files according to one embodiment of the present invention. Referring to FIG. 2, after the firmware package is downloaded into the first storage unit at S105, the setup information file and firmware code files are written into the second storage unit as described in detail below. At step S205, it is checked whether the remaining space of the first storage unit is sufficient for storing local data, i.e. whether the remaining space of the first storage unit is sufficient for storage of the local data. If the remaining space of the first storage unit is sufficient for storing the local data, the local data in the data partition is backed up to the first storage unit at step S210. At step S215, the local data in the data partition is then erased. At step S220, the setup information file and firmware code files are respectively written into the profile partition and the data partition. The detail process of the writing has been described with reference to the step S110 of FIG. 1 and therefore is not repeated herein. Then, the method returns to step S113 to restart the embedded electronic device.

On the contrary, if the remaining space of the first storage unit is not sufficient for storing the local data, it is prompted that the firmware package backup is failed, and the updating program is exited.

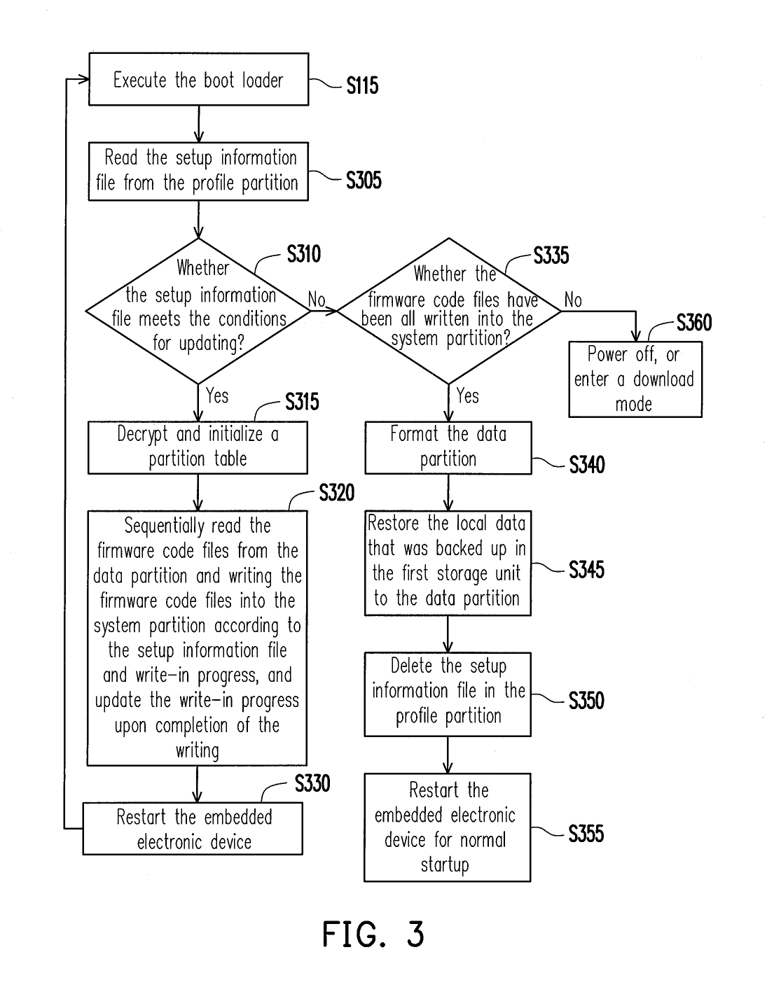

FIG. 3 is a flow chart of firmware writing operation according to one embodiment of the present invention. Referring to FIG. 3, after the execution of boot loader at step S115, the firmware writing operation is described in detail below. At step S305, the boot loader reads the setup information file from the profile partition to determine whether the setup information file meets the conditions for updating, e.g. whether the firmware package is of a latest version, at step S310. At step S315, the boot loader decrypts and initializes a partition table for subsequent writing operations according to the partition table. At step S320, the boot loader sequentially reads respective firmware code files from the data partition, writes the same into the system partition according to the setup information file and write-in progress, and updates the write-in progress upon completion of the writing. In the present embodiment, the write-in progress is one of the columns in the setup information file. In an alternative embodiment, the write-in progress may also be a file in the data partition other than the setup information file.

After the firmware update is completed, the embedded electronic device is restarted at step S330 to perform step S115 repeatedly. Likewise, the boot loader reads the setup information file from the profile partition at step S305 and determines whether the setup information file meets the conditions for updating. If it is determined that the setup information file does not meet the conditions for updating (e.g. the firmware package is not of a latest version), then it is further determined whether the firmware code files have been all written into the system partition at step S335. If it is determined that the firmware code files have been all written into the system partition, it represents that the firmware code files have been all updated. Thus, at step S340, the data partition is formatted by the boot loader to erase the firmware code files in the data partition. At step S345, the boot loader then restores the local data backup in the first storage device to the data partition. At step S350, the boot loader deletes the setup information file in the profile partition. At last, at step S335, the embedded electronic device is restarted for normal startup.

On the other hand, if the setup information file in the profile partition does not meet the conditions for updating and the firmware code files have not been all written into the system partition, it represents that the firmware package is in an illegal state or the firmware package download is incomplete. As such, the embedded electronic device is powered off or enters a download mode to re-download the firmware package at step S360.

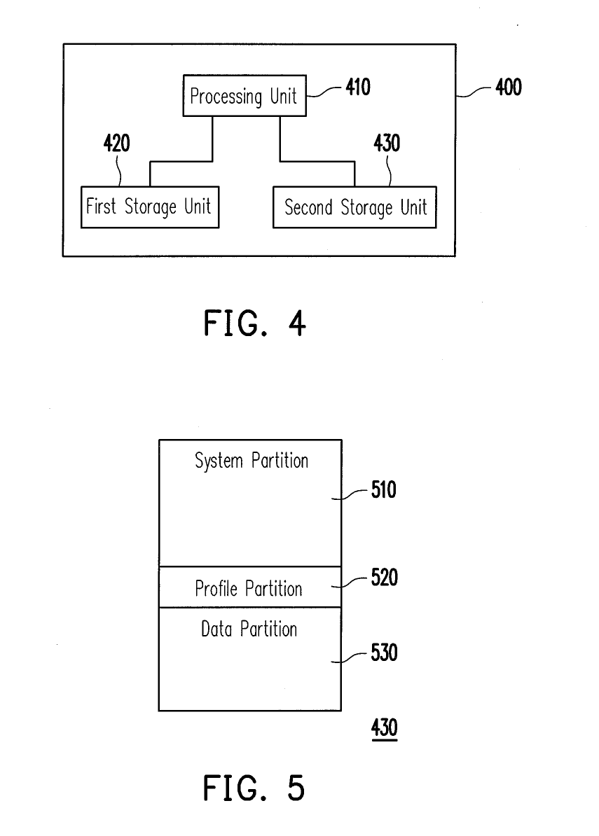

Another embodiment of the embedded electronic device carrying out the above method is described below. FIG. 4 is a block diagram of an embedded electronic device according to one embodiment of the present invention. Referring to FIG. 4, the embedded electronic device 400 includes a processing unit 410, a first storage unit 420 and a second storage unit. The processing unit 410 is coupled to the first storage unit 410 that stores the loaded firmware package, and acts as a second storage unit 430 of the carrier.

The second storage unit 430 includes a profile partition, a data partition and a system partition. FIG. 5 illustrates an exemplary second storage unit 430 according to one embodiment of the present invention. Referring to FIG. 5, the second storage unit 430 includes a system partition 510, a profile partition 520 and a data partition 530. The system partition 510 at least stores the firmware of the embedded electronic device. The profile partition 520 is used to store profile files such as the setup information file (e.g. fw.inf). The data partition 530 is used to store the local data.

In addition, the processing unit 410 operates to download the firmware package into the first storage unit 420 and then read the setup information file and firmware code files from the first storage unit 420 to write the same into the profile partition 520 and data partition 530, respectively. Afterwards, the processing unit 410 operates to restart the embedded electronic device and execute the boot loader in the system partition 510, for example, an original equipment manufacturer secondary boot loader (OEMSBL) to perform the firmware writing operations. The firmware writing operations have been described above with reference to steps S120, S305 to S360 and therefore explanation thereof is not repeated herein.

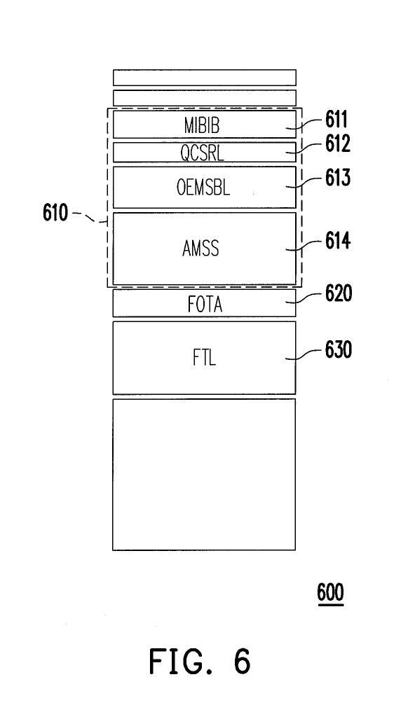

The firmware update program is described below in conjunction with a NAND flash memory. FIG. 6 illustrates a NAND flash memory according to one embodiment of the present invention. Referring to FIG. 6, the NAND flash memory 600 at least includes a system partition 610, a firmware over-the-air (FOTA) partition 620 and a flash translation layer (FTL) partition 630. The system partition 610 includes a partition table (e.g. MIBIB) 611, a Qualcomm secondary boot loader (QCSBL) 612, an OEMSBL 613 and an advanced mobile subscriber software (AMSS) 614. The functions of the FOTA partition 620 and the FTL partition 630 are the same as the functions of the profile partition 520 and the data partition 530, respectively, and therefore explanation thereof is not repeated herein.

In the present embodiment, the first storage unit is, for example, a TF card, and the setup information file of the firmware package is, for example, fw.inf. In addition, fw.inf includes fw_status for recording the write-in progress, which at least includes the status of ready-to-update (FW_READY_TO_UPDATE) and represents each firmware code file (FW_IN_PARTI_INIT, FW_IN_QCSBL, FW_IN_OEMSBL, FW_IN_AMSS) to indicate current write-in progress.

A further description of the firmware update program is described below in conjunction with steps S105 to S130 of FIG. 1. If the firmware package is downloaded into the TF card at step S105, fw.inf is generated in the TF card during FOTA stage. The subsequent step S110 is detailed below. The firmware package in the TF card is parsed into the NAND flash memory 600, fw.inf is recorded at the initial position of the FOTA partition 620 in a binary manner, which occupies one block and consists of 32 pages with a size of 16 KB. At this time, it is prompted that there is a new version of firmware package for updating. The header message (a total of 256 bytes) of the firmware package is then clustered to the fw.inf in the TF card to retrieve the firmware code files from the firmware package and write the same into the NAND flash memory 600 (from the first block of the FTL partition 630) according to the header message.

After the firmware code files in the TF card have been all written into the FTL partition 630, the CRC check is performed on the firmware code files in the FTL partition 630. If the check is successful, fw_status in fw.inf of the FOTA partition 620 is updated to FW_READY_TO_UPDATE. The fw.inf is written into the FOTA partition 620 (written into a next one in case of a bad block). Furthermore, a backup of the fw.inf is generated which is to be written into a next block (written into a next one in case of a bad block) of the FOTA partition 620.

It is noted that the firmware writing operation at step S120 is performed by OEMSBL 613. The OEMSBL 613 searches in the FOTA partition 620 to obtain a data structure of the fw_inf and then determines whether fw_status of fw_inf is RW_READY_TO_UPDATE or not to thereby determine whether the firmware code files in the FTL partition 630 and the fw_inf header message are both normal. If the fw_status of the firmware package is not FW_READY_TO_UPDATE, the current write-in progress is then determined to continue the updating operations.

The write-in progress fw_status is updated upon completion of updating of each firmware code file. For example, once writing of the firmware code file AMSS is completed, fw_status is updated to FW_In_AMSS. It is noted that this is for the purposes of illustration only and should not be regarded as limiting.

In addition, it is noted that, for a larger firmware code file (e.g., larger then 5 MB), in addition to updating the write-in progress fw_status, the write-in progress may further be recorded to another column such as fw_process (also in fw.inf) upon completion of writing each 5 MB of the file till updating of the total file is completed. If an interrupt of power supply occurs during updating, subsequent updating can be continued by referring to the fw_status and fw_process after the embedded electronic device is restarted.

In summary, in the present invention, the firmware package is obtained under the support of the file system and transformed into directly readable image data in advance, such that the boot loader that does not support the file system can directly fetch the firmware package to thereby achieve the firmware update. In addition, the write-in progress of the firmware code files is recorded during updating. This makes sure that, even if the embedded electronic device is restarted during any of the writing stages, the embedded electronic device can continue to update the rest of the firmware code files according to the write-in progress of the previous writing operation, thus increasing the possibility of successful firmware update.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A firmware updating method applied to an embedded electronic device including a first storage unit and a second storage unit, the second storage unit including a profile partition, a data partition and a system partition, the system partition at least storing a firmware of the embedded electronic device, the method comprising:
downloading a firmware package into the first storage unit, the firmware package including a setup information file and a plurality of firmware code files;
writing the setup information file and the firmware code files to the profile partition and the data partition, respectively; and
restarting the embedded electronic device and executing a boot loader in the system partition to execute a firmware writing operation, the firmware writing operation comprising:
sequentially reading the firmware code files from the data partition and writing the firmware code files into the system partition according to the setup information file in the profile partition; and
updating a write-in progress in the profile partition upon completion of writing of each of the firmware code files, such that after the embedded electronic device is restarted after an interruption of power supply, the boot loader continues to write the rest of the firmware code files into the system partition according to the write-in progress.

2. The firmware updating method according to claim 1, wherein the firmware writing operation further comprises:
determining whether each of the firmware code files exceeds a predetermined size;
if the firmware code file size exceeds the predetermined size, updating the write-in progress upon completion of writing of each the predetermined size, and also updating the write-in progress upon completion of writing of each entire firmware code file; and
if the firmware code file size does not exceed the predetermined size, updating the write-in progress upon completion of writing of each of the firmware code files.

3. The firmware updating method according to claim 1, wherein, after downloading the firmware package into the first storage unit, the method further comprises:
checking whether the remaining space in the first storage unit is sufficient for storing local data in the data partition;
backing up the local data in the data partition to the first storage unit if the remaining space in the first storage unit is sufficient for storing the local data; and
erasing the local data from the data partition.

4. The firmware updating method according claim 3, wherein after the step of executing the boot loader, the firmware updating method further comprises:
determining whether the setup information file in the profile partition meets a condition for updating;
executing the firmware writing operation by using the boot loader if the condition for updating is met; and
checking the write-in progress so as to determine whether the firmware code files have been all written into the system partition if the condition for updating is not met.

5. The firmware updating method according to claim 4, wherein, if it is determined that the firmware code files have been all written into the system partition, the method further comprises:
formatting the data partition;
restoring the local data backed up in the first storage unit to the data partition; and
deleting the setup information file in the profile partition.

6. The firmware updating method according to claim 4, wherein, if the setup information file in the profile partition does not meet the condition for updating and it is determined that the firmware code files have not all been written into the system partition, the method further comprises:
entering a downloading mode to re-download the firmware package.

7. The firmware updating method according to claim 1, wherein the firmware writing operation further comprises:
decrypting and initializing a partition table in the system partition.

8. The firmware updating method according to claim 1, wherein respectively writing the setup information and the firmware code files into the profile partition and the data partition comprises:
recording the setup information file into the profile partition in a binary manner;
parsing a header message of the firmware package; and
writing the firmware code files into the data partition in a binary manner according to the header message so as to transform the firmware code files into image data.

9. The firmware updating method according to claim 1, wherein after downloading the firmware package into the first storage unit, the method further comprises:
verifying a cycle redundancy check (CRC) code of the firmware package.

10. The firmware updating method according to claim 1, wherein the first storage unit is a micro secure digital (Micro SD) card, and the second storage unit is a NAND flash.

11. An embedded electronic device comprising:
a first storage unit for storing a loaded firmware package including a setup information file and a plurality of firmware code files;
a second storage unit comprising a profile partition, a data partition and a system partition, the system partition at least storing a firmware of the embedded electronic device;
a processing unit coupled to the first storage unit and the second storage unit, wherein the processing unit is used for downloading a firmware package into the first storage unit, accessing the setup information file and the firmware code files so as to write the same to the profile partition and the data partition, respectively; and executing a boot loader in the system partition to execute a firmware writing operation if the embedded electronic device is restarted, the firmware writing operation comprising:
sequentially reading the firmware code files from the data partition and writing the firmware code files into the system partition according to the setup information file in the profile partition; and
updating a write-in progress in the profile partition upon completion of writing of each of the firmware code files, such that after the embedded electronic device is restarted after an interruption of power supply, the boot loader continues to write the rest of the firmware code files into the system partition according to the write-in progress.

12. The embedded electronic device according to claim 11, wherein the firmware writing operation further comprises:
determining whether each of the firmware code files exceeds a predetermined size;
if the firmware code file size exceeds the predetermined size, updating the write-in progress upon completion of writing of each the predetermined size, and also updating the write-in progress upon completion of writing of each entire firmware code file; and
if the firmware code file size does not exceed the predetermined size, updating the write-in progress upon completion of writing of each of the firmware code files.

13. The embedded electronic device according to claim 11, wherein, after downloading the firmware package into the first storage unit, the processing unit is further used for:
checking whether the remaining space in the first storage unit is sufficient for storing local data in the data partition;
backing up the local data in the data partition to the first storage unit if the remaining space in the first storage unit is sufficient for storing the local data; and
erasing the local data from the data partition.

14. The embedded electronic device according to claim 13, wherein, after executing the boot loader, the processing unit is further used for:
determining whether the setup information file in the profile partition meets a condition for updating;
executing the firmware writing operation by using the boot loader if the condition for updating is met; and
checking the write-in progress so as to determine whether the firmware code files have been all written into the system partition if the condition for updating is not met.

15. The embedded electronic device according to claim 14, wherein, if the processing unit determines that the firmware code files have been all written into the system partition, the processing unit is further used for:
formatting the data partition;
restoring the local data backed up in the first storage unit to the data partition; and
deleting the setup information file in the profile partition.

16. The embedded electronic device according to claim 14, wherein, if the processing unit determines that the setup information file in the profile partition does not meet the condition for updating and determines that the firmware code files have not all been written into the system partition, the processing unit is further used for entering a download mode to re-download the firmware package.

17. The embedded electronic device according to claim 11, wherein the firmware writing operation further comprises:
decrypting and initializing a partition table in the system partition.

18. The embedded electronic device according to claim 11, wherein the processing unit records the setup information file into the profile partition in a binary manner, parses a header message of the firmware package; and writes the firmware code files into the data partition in a binary manner for transforming the firmware code files into image data according to the header message so as to write the setup information and the firmware code files into the profile partition and the data partition comprises, respectively.

19. The embedded electronic device according to claim 11, wherein after downloading the firmware package into the first storage unit, the processing unit is further used for verifying a cycle redundancy check code of the firmware package.

20. The embedded electronic device according to claim 11, wherein the first storage unit is a micro secure digital card, and the second storage unit is a NAND flash.
